(19) United States
(12) Patent Application Publication
(10) Pub. No.: US 2007/0264984 A1
(43) Pub. Date: Nov. 15, 2007

(54) REAL DEMO MODE

(76) Inventors: Bengt STAVENOW, Lund (SE); Kristoffer ABERG, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/460,327

(22) Filed: Jul. 27, 2006

Related U.S. Application Data
(60) Provisional application No. 60/744,419, filed on Apr. 7, 2006.

(51) Int. Cl. H04Q 7/38; H04Q 7/22; H04M 3/42

(52) U.S. Cl. 455/414.1

(57) ABSTRACT

The present invention is directed to a method for demonstrating an electronic device, said device is adapted for wireless network connection, comprising a real demo step for executing applications of said electronic device, said applications do not requiring to identify and/or connect to said wireless network connection. The present invention is further directed to a corresponding device adapted for wireless network connection.

This application claims priority under 35 U.S.C. § 119 to U.S. Provisional Application No. 60/744,419, filed Apr. 7, 2006, the entire disclosure of which is incorporated herein by reference.

### TECHNICAL FIELD OF THE INVENTION

The present invention relates to an electronic device adapted for wireless communication and in particularly to the field of wireless electronic devices adapted for communication within a wireless network such as a wireless cellular network. The present invention further relates to a corresponding method for communicating with said wireless network.

Mobile phones differ from other types of consumer electronic devices (including fixed and home cordless telephones) in that they require entry of PIN codes, registration on a network, etc., whereas other consumer electronics devices only have to be switched on to be fully operational. This has the effect of mobile phones being perceived as unnecessarily complex to operate, slow to start up, and also hard to demonstrate to prospective customers. In a point-of-sales situation, a subscription/SIM card is necessary to demonstrate the phones full feature set, which effectively stops the majority of salespeople from demonstrating phones, and most users from being able to get an impression of the mobile phone until after they have bought it. This is unfortunate because the user is most likely already familiar with basic phone functionality, but not with other phone features that do not require wireless network connection but still cannot be demonstrated. Some phone models have a so called demo mode, which allows demonstration of the phone functionality by way of e.g. a slideshow or movie that simulates the use of phone features. But this does not solve most or any of the problems listed above.

### SUMMARY

According to the present invention, a device and a method are provided for operating an wireless electronic device adapted for wireless network connection. The invention is suitable for avoiding inadvertent calls while still utilizing said electronic device.

Further, the invention is suitable for supporting a salesperson in selling said wireless electronic device.

In accordance with a particular aspect of the invention, a wireless electronic device adapted for communication in a wireless network is provided. The device includes a real demo mode operable to execute an application of said wireless electronic device without identification and/or connection of said wireless electronic device with said wireless network.

Favorably, said wireless electronic device is operable to receive and/or obtain identification data and/or other types of data.

Favorably, said real demo mode is operable in reference to device settings, said device settings being based on said data.

Favorably, said real demo mode is operable to process said data.

Favorably, said real demo mode is operable to save, discard and/or restore said data.

Favorably, said data is obtained from a user authorization input.

Favorably, said data is obtained from an identification device.

Favorably, said identification device comprises a SIM card, a UICC and/or a PDC.

Favorably, said data is obtained from a database device.

Favorably, said data is processed at the start, during and/or at the end of the real demo mode.

Favorably, said wireless electronic device comprises a normal mode operable to execute at least one application of said wireless electronic device with identification and/or connection of said wireless electronic device with said wireless network.

According to another aspect of the invention, a method is provided for operating a wireless electronic device adapted for communication in a wireless network. The method includes a real demo mode step for executing an application of said wireless electronic device without identification and/or connection of said wireless electronic device with said wireless network.

Favorably, said method comprises steps for receiving and/or obtaining identification data and/or other types of data.

Favorably, said real demo mode step is based on device settings, said device settings being based on said data.

Favorably, said real demo mode step is for processing said data.

Favorably, said real demo mode step is for saving, discarding and/or restoring said data.

Favorably, said data is obtained from a user authorization input step.

Favorably, said data is obtained from an identification device inserting step.

Favorably, said identification device inserting step is based on the insertion of a SIM card, a UICC and/or a PDC.

Favorably, said data is obtained from a database device reading out step.

Favorably, said data is processed at the start, during and/or at the end of the real demo mode step.

Favorably, said method for operating an wireless electronic device adapted for communication in a wireless network, comprises a normal mode step for executing at least one application of said wireless electronic device with identification and/or connection of said wireless electronic device with said wireless network, said normal mode step comprises the above-mentioned method.

The term “electronic device” includes portable radio communication equipment. The term “portable radio communication equipment”, which herein after is referred to as a mobile radio terminal, includes all equipment such as mobile telephones, pagers, communicators, i.e. electronic organizers, smartphones or the like.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The above and other aspects, features and advantages of the present invention will become more apparent from the following detailed description when taken in conjunction with the accompanying drawings, in which:

FIG. 1 shows an example of a schematic setup of a wireless electronic device, said device comprising an embodiment of the present invention;

FIG. 2 shows a schematic setup of different operation modes, said setup comprising an alternative embodiment of the present invention;

FIG. 3 shows an example of a schematic block diagram comprising an alternative embodiment of the present invention;

FIG. 4 shows another example of a schematic block diagram comprising an alternative embodiment of the present invention; and

FIG. 5 shows another example of a schematic block diagram comprising an alternative embodiment of the present invention.

### DETAILED DESCRIPTION OF EMBODIMENT

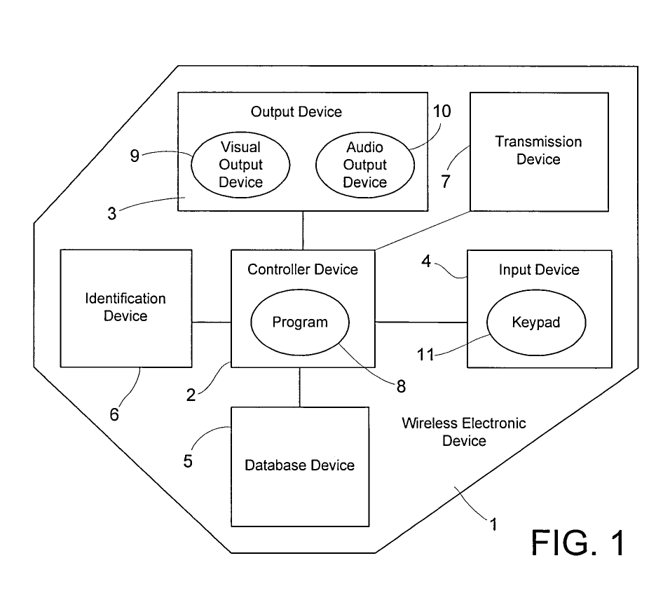

FIG. 1 shows an example of a schematic setup of a wireless electronic device 1 comprising a controller device 2, an output device 3, a input device 4, a database device 5, an identification device 6 and a transmission device 7. Moreover said controller device 2 comprises a program 8, said program 8 comprising an embodiment of the present invention. The program 8 comprises a software and/or a hardware implementation like for example a computer program and/or a programmed memory storage.

The wireless electronic device 1 is operable to execute a divers number of different applications and/or to establish a connection via the transmission device 7 to a mobile communication network (not shown in FIG. 1). In addition to wireless network connection this mobile communication network might comprise also Bluetooth, WLAN (wireless local area network) and/or other types of network connections known to a skilled person. The term wireless electronic device comprises portable and mobile computing devices such as Personal Computers (PC), Personal Digital Assistants (PDA), peripherals, cell phones, pagers and consumer electronics. Preferably the wireless electronic device 1 is a cell phone.

The controller device 2 is operable to control the wireless electronic device 1 by processing and forwarding data of said device 1. In particular the controller device 2 is operable to receive data from input device 4, database 5, identification device 6, transmission device 7 and/or program 8, process and sent said data to output device 3, database 5 and/or other devices requiring data from prior mentioned devices. The controller device 2 might comprise for example a CPU (central processing unit). All above-mentioned devices 3, 4, 5, 6 and 7 are controlled by the controller device 2. The program 8 is not limited to this position, but can be located for example in the database 5.

The output device 3 comprises a visual output device 9 and/or an audio output device 10 and is operable to output data sent by the controller device 2 via said devices 9 and/or 10. Preferably the visual output device 9 comprises at least one display and the audio output device 10 comprises at least one speaker.

The input device 4 preferably comprises a keypad 11 and is operable to receive data input by a user, said data being sent to the controller device 2. Of course the input device 4 is not limited to the example comprising the keypad 11 as known to a skilled person.

The database 5 is operable to store data sent by the controller device 2 and send data requested by the controller device 2. An operating system and/or applications is/are located in said database 5, but is/are not limited to this example. Said data of database 5 comprises different kinds of data like for example music data, address book entries, pictures and other types known to a skilled person. Said applications comprise applications requiring wireless network connection and/or applications not requiring wireless network connection.

The identification device 6 comprises for example a SIM (Subscriber Identity Module) card, an UICC (Universal Integrated Circuit Card) and/or a PDC (Personal Digital Cellular) and is operable to send data to the controller device 2, said data identifying a user. Moreover said data might comprise further information regarding the user or other information known to a skilled person. When a user inserts for example said SIM card and is eventually authorized by the wireless communication network, the user may make a phone call or utilize other applications requiring identification and/or connection to a wireless communication network, known to a skilled person.

The transmission device 7 is operable to send and/or receive data via electro-magnetic radio waves for mobile communication, said data is further received by and/or sent to the controller device 2. It is clear, that there are different applications, wherein some applications need access to the mobile communication network and some do not require said access. Furthermore said mobile communication network comprises wireless network connection, Bluetooth, WLAN and/or other networks known to a skilled person.

The program 8 is operable to allow the utilization of non-wireless network connection and/or non-wireless network identification requiring applications of said wireless electronic device 1. In case the user has inserted no identification device 6 into the wireless electronic device 1 and/or has input no and/or wrong authentication code for said wireless network or for said wireless electronic device 1, a real demo mode can be engaged or accessed wherein the user may still access applications which do not require a identification and/or connection to said wireless communication network. Thus no charges for possible wireless network connections will be caused. Said applications comprise the composition of SMS (short message service) and/or MMS (Multimedia Messaging Service), the usage of address and/or phone book for inserting for example new phone numbers, the usage of the calendar, the usage of the internal camera and/or storing of pictures, the playing of music data and/or other applications known to a skilled person.

Furthermore the embodiment might be implemented as hardware and/or software.

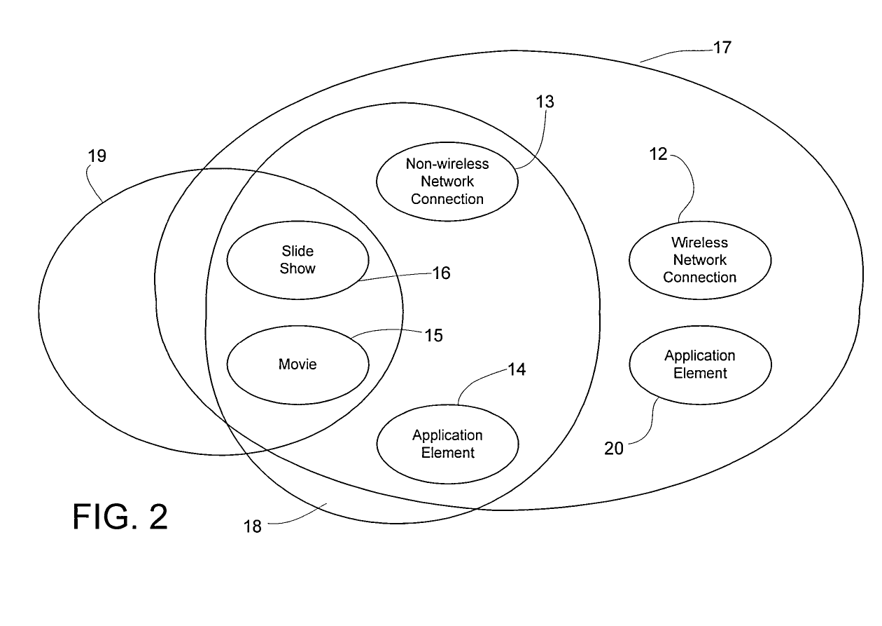

FIG. 2 shows an example of schematic setup of different operation modes comprising a normal mode element 17, said element 17 comprising a real demo mode element 18, said element 18 being an alternative embodiment of the present invention. These operation modes are implemented into the program 8, the controller 2, the database 5 and/or other preferable locations known to a skilled person of the wireless electronic device 1 of FIG. 1.

Said normal mode element 17 comprises a wireless network connection for mobile communication-element 12, an application element 20 requiring said element 12 and at least a portion of the real demo mode element 18. The normal mode element 17 is operable to connect to said wireless network via connection element 12 and to allow to execute application element 20. Since applications and/or data of the real demo mode element 18 and/or the demo mode element 19 are accessible by the normal mode element 17, a non-wireless network connection for mobile communication-element 13, an application element 14 (described later in detail), data of a movie 15 and a slide show 16 for demonstration are a part of said normal mode element 17. Said application element 14 does not require said wireless network connection 12, but might be operable to use said wireless network connection 12 and/or said non-wireless network connection 13. Said element 14 comprises applications like the composition of SMS (short message service) and/or MMS (Multimedia Messaging Service), the usage of address and/or phone book for inserting for example new phone numbers, the usage of the calendar, the usage of the internal camera and/or storing of pictures, the playing of music data and/or other applications, which do not require a wireless network connection 12, known to a skilled person. Non-wireless network connection comprises Bluetooth, WLAN, and/or other non-chargeable, non-cellular and/or non-identification requiring communication as known by a person skilled in the art. Other examples of the said normal mode element 17 and/or other embodiments of said real demo mode element 18 respectively comprising at least said elements 14 are possible.

The real demo mode element 18 comprises the non-wireless network connection for mobile communication-element 13, the application element 14 and at least a portion of said demo mode element 19. The real demo mode element 18 is operable to connect to non-wireless communication network via connection element 13 and/or to allow to execute application element 14. Since applications and/or data of the demo mode element 19 are accessible by the real demo mode element 18, data of the movie 15 and the slide show 16 for demonstration are a part of said real demo mode element 18. Other embodiments of said real demo mode element 18 comprising none, other, less and/or more elements of said demo mode element 19 are possible. The demo mode element 19 comprises data of the movie 15 and the slide show 16 for demonstration and is operable to process and output said data 15 and/or 16 for reasons of demonstration. The demo mode element 19 might allow less interaction by a user than said real demo mode element 18 and/or normal mode element 17, but is not limited to this example. The movie 15 shows for example the usage of applications 20 accessible in the normal mode element 17 of said wireless electronic device 1. The slide show 16 is similar operable to said movie 15.

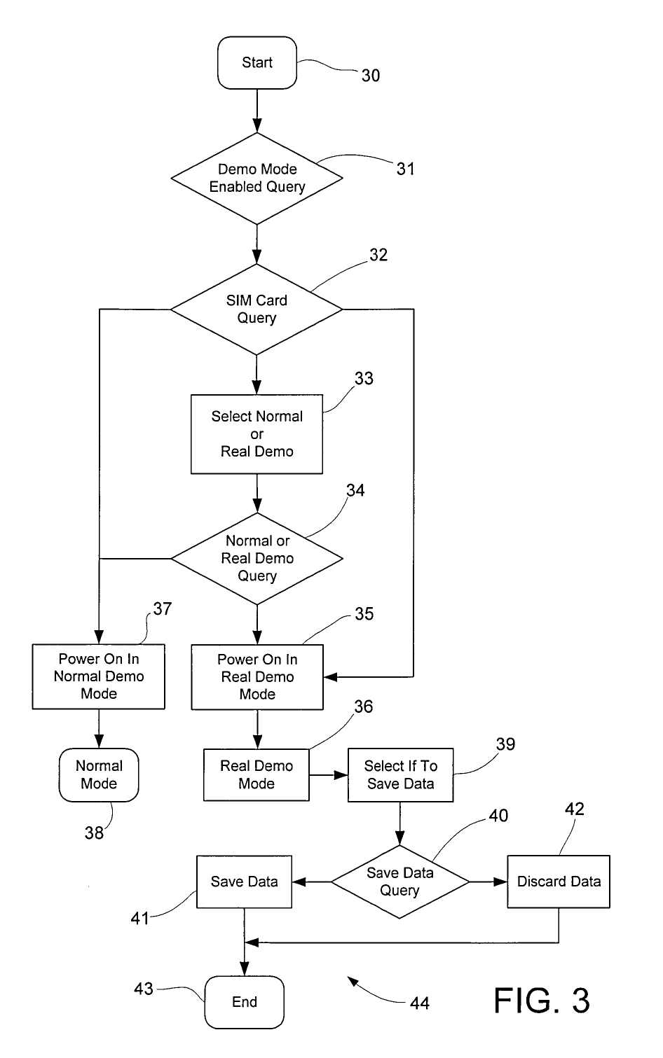

FIG. 3 shows an example of a schematic block diagram of a start-up method 44 comprising a real demo mode step 36, said step 36 comprising an alternative embodiment of the present invention.

The start-up method 44 comprises the steps 30 to 43 and is operable to be executed in and/or part of program 8 on a wireless electronic device 1 described in FIG. 1. In particular said method 44 is operable to offer the choice between the normal mode step 38 and the real demo mode step 36 with a following save data query-step (described later in detail). The normal mode step 38 and the real demo mode step 36 are the same as the normal mode element 17 and the real demo mode element 18 described in FIG. 2, respectively.

The start—step 30 indicates the starting point of the block diagram and further leads to the “demo mode enabled query”—step 31.

Said “demo mode enabled query”—step 31 is for asking whether the demo mode was set. If no demo mode was set, then the block diagram proceeds to “power on in normal mode”—step 37. Otherwise if the demo mode was set, then the block diagram proceeds to “SIM card query”—step 32. The demo mode can be set by said input device 4 and/or prior set software and/or hardware setting.

Said “power on in normal mode”—step 37 is for powering on the wireless electronic device 1 in normal mode, said normal mode is the same as the normal mode 17 described in FIG. 2. After said step 37 the block diagram proceeds to the “normal mode”—step 38, said step 38 indicating the wireless electronic device 1 now being engaged in the normal mode and starting said normal mode.

Said “SIM card query”—step 32 is for asking whether a SIM card is inserted into the wireless electronic device 1 or not. If no SIM card is inserted, then the block diagram proceeds to “power on in real demo mode”—step 35. Otherwise if a SIM card is inserted, then the block diagram proceeds to “select normal or real demo”—step 33.

Said “select normal or real demo”—step 33 is for presenting the options comprising the normal mode and the real demo mode, said options can be output for example by the visual output device 9 described in FIG. 1. After said step 33 the block diagram proceeds to “normal or real demo query”—step 34.

Said “normal or real demo query”—step 34 is for asking whether the real demo mode was set or not. If the real demo mode was not set, then the block diagram proceeds to said step 37. Otherwise if the real demo mode was set, then the block diagram proceeds to said step 35.

Said “power on in real demo mode”—step 35 is for powering on the wireless electronic device 1 in real demo mode, said real demo mode is the same as the real demo mode 18 described in FIG. 2. After said step 35 the block diagram proceeds to the “real demo mode”—step 36, said step 36 indicating the wireless electronic device 1 now being engaged in the real demo mode and starting said real demo mode. After said step 36, when the user decided to exit the real demo mode, the block diagram proceeds to the “select if to save data”—step 39.

Said “select if to save data”—step 39 is for presenting the options whether to save the data created and/or modified during the real demo mode or not and/or which data to be saved or not, said options can be output for example by the visual output device 9 described in FIG. 1. After said step 39 the block diagram proceeds to “save data query”—step 40.

Said “save data query”—step 40 is for asking whether to save the data created and/or modified during the real demo mode or not. If no data is to be saved, then the block diagram proceeds to “discard data”—step 42. Otherwise if data is to be saved, then the block diagram proceeds to “save data”—step 41.

Said “save data”—step 41 is for saving data created and/or modified during the real demo mode.

Said “discard data”—step 42 is for discarding above-mentioned data.

After said step 41 and 42 the block diagram proceeds to end-step indicating the end of the block diagram and for example shutting down said wireless electronic device 1. All query steps 31, 32, 34 and 40, respectively, can be answered, respectively processed by a user input and/or hardware and/or software setting.

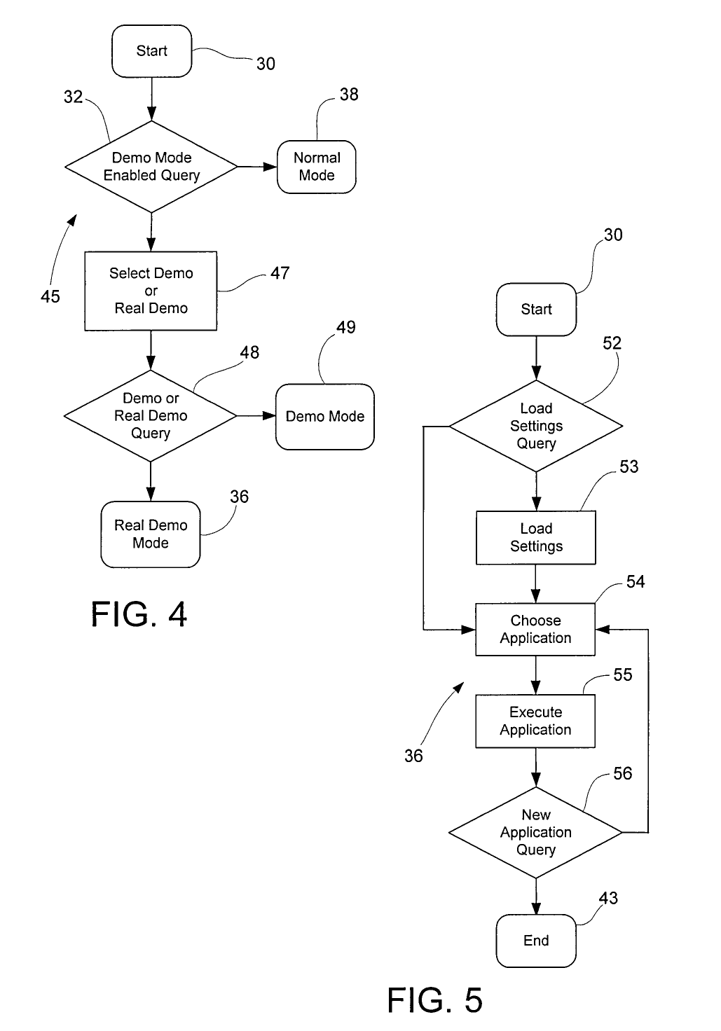

FIG. 4 shows an example of a schematic block diagram of an other start-up method 45 comprising a real demo mode step 36, a demo mode step 49 and a normal mode step 38, said step 36 being an alternative embodiment of the present invention.

The start-up method 45 comprises the steps 30, 32, 36, 38, 47, 48 and 49 and is operable to be executed in and/or be part of said program 8 on a wireless electronic device 1 described in FIG. 1. In particular said method 45 is operable to offer the choice between the normal mode step 38, the real demo mode step 36 and the demo mode step 49. The normal mode step 38, the real demo mode step 36 and the demo mode step 49 are the same as the normal mode element 17, the real demo mode element 18 and the demo element 19 described in FIG. 2, respectively.

The start-step 30 indicates the starting point of the block diagram and further leads to the “demo mode enabled query”—step 32.

Said “SIM card query”—step 32 is for asking whether a SIM card is inserted into the wireless electronic device 1 or not. If no SIM card is inserted, then the block diagram proceeds to “select demo or real demo”—step 47. Otherwise if a SIM card is inserted, then the block diagram proceeds to normal mode step 38.

Said “select demo or real demo”—step 47 is for presenting the options whether to choose the real demo mode 36 or the demo mode 49, said options can be output for example by the visual output device 9 described in FIG. 1. After said step 47 the block diagram proceeds to “demo or real demo query”—step 48.

Said “demo or real demo query”—step 48 is for asking whether the demo mode or the real demo mode was selected. If the demo mode was selected, the block diagram proceeds to the demo mode step 49. Otherwise if the real demo mode was selected, the block diagram proceeds to the real demo mode step 36.

All above-mentioned query steps can be answered by a user input and/or hardware and/or software setting.

FIG. 5 shows a schematic block diagram of an alternative embodiment of a real demo mode 36 comprising a start-step 30, a “load settings query”—step 52, a “load settings”—step 53, a “choose application”—step 54, an “execute application”—step 55, a “new application query”—step 56 and an end-step 43.

The start-step 30 indicates the starting point of the block diagram and further leads to the “load settings query”—step 52.

Said “load settings query”—step 52 is for asking whether to load predefined settings for the real demo mode 36 or not. If predefined settings are to be loaded, then the block diagram continues to “load settings”—step 53. If no predefined settings are to be loaded, then the block diagram continues to “choose application”—step 54.

Said “load settings”—step 53 is for loading said predefined settings for the real demo mode 36. After this step 53 the block diagram continues to said step 54.

Said “choose application”—step 54 is for choosing an application of a wireless electronic device 1 described in FIG. 1. Then the block diagram continues to said “execute application”—step 55.

Said “execute application”—step 55 is for executing said chosen application and continues after the application was executed to said “new application query”—step 56. Said “new application query”—step 56 is for asking whether to choose a new application to be executed or to end the real demo mode. If a new application is to be executed, the block diagram proceeds to said step 54. If the real demo mode shall end, the block diagram proceeds to end—step 43.

The end—step 43 indicates the ending point of the block diagram and exits the real demo mode. After said step 43 other predetermined applications can be executed, the wireless electronic device 1 can be shut down or the real demo mode 36 can be restarted.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

### REFERENCE LIST

1 wireless electronic device
2 controller device
3 output device
4 input device
5 database
6 identification device
7 transmission device
8 program
9 visual output device
10 audio output device
11 keypad
12 wireless network connection for mobile communication
13 non-wireless network connection for mobile communication
14 application not requiring wireless network connection
15 movies for demonstration
16 slide shows for demonstration
17 normal mode
18 real demo mode
19 demo mode
20 application requiring wireless network connection
30 start-step
31 demo mode enabled query-step
32 SIM card query-step
33 select normal or real demo-step
34 normal or real demo query-step
35 power on in real demo mode-step
36 real demo mode-step
37 power on in normal mode-step
38 normal mode-step
39 ask if to save data-step
40 save data query-step
41 save data-step
42 discard data-step
43 end-step
44 start-up method (1. example)
45 start-up method (2. example)
47 select demo or real demo-step
48 demo or real demo query-step
49 demo mode-step
52 load settings query-step
53 load settings-step
54 choose application-step
55 execute application-step
56 new application query-step

1. A wireless electronic device adapted for communication in a wireless network, comprising
a real demo mode operable to execute an application of said wireless electronic device without identification and/or connection of said wireless electronic device with said wireless network.

2. A wireless electronic device according to claim 1, wherein said wireless electronic device is operable to receive and/or obtain identification data and/or other types of data.

3. A wireless electronic device according to claim 2, wherein said real demo mode is operable in reference to device settings, said device settings being based on said data.

4. A wireless electronic device according to claim 2, wherein said real demo mode is operable to process said data.

5. A wireless electronic device according to claim 2, wherein said real demo mode is operable to save, discard and/or restore said data.

6. A wireless electronic device according to claim 2, wherein said data is obtained from a user authorization input.

7. A wireless electronic device according to claim 2, wherein said data is obtained from an identification device.

8. A wireless electronic device according to claim 7, wherein said identification device comprises a SIM card, a UICC and/or a PDC.

9. A wireless electronic device according to claim 2, wherein said data is obtained from a database device.

10. A wireless electronic device according to claim 2, wherein said data is processed at the start, during and/or at the end of the real demo mode.

11. A wireless electronic device according to claim 1, comprising a normal mode operable to execute at least one application of said wireless electronic device with identification and/or connection of said wireless electronic device with said wireless network.

12. A method for operating a wireless electronic device adapted for communication in a wireless network, comprising
a real demo mode step for executing an application of said wireless electronic device without identification and/or connection of said wireless electronic device with said wireless network.

13. A method according to claim 12, comprising steps for receiving and/or obtaining identification data and/or other types of data.

14. A method according to claim 13, wherein said real demo mode step is based on device settings, said device settings being based on said data.

15. A method according to claim 13, wherein said real demo mode step is for processing said data.

16. A method according to claim 13, wherein said real demo mode step is for saving, discarding and/or restoring said data.

17. A method according to claim 13, wherein said data is obtained from a user authorization input step.

18. A method according to claim 13, wherein said data is obtained from an identification device inserting step.

19. A method according to claim 18, wherein said identification device inserting step is based on the insertion of a SIM card, a UICC and/or a PDC.

20. A method according to claim 13, wherein said data is obtained from a database device reading out step.

21. A method according to claim 13, wherein said data is processed at the start, during and/or at the end of the real demo mode step.

22. A method for operating an wireless electronic device adapted for communication in a wireless network, comprising
a normal mode step for executing at least one application of said wireless electronic device with identification and/or connection of said wireless electronic device with said wireless network,
said normal mode step comprises a method according to claim 12.
